(19) United States
(12) Patent Application Publication
(10) Pub. No.: US 2015/0021433 A1
(43) Pub. Date: Jan. 22, 2015

(54) SYSTEM AND METHOD FOR A TOWABLE AND INFLATABLE RECREATIONAL DEVICE WITH A RETRACTABLE WIND FOIL

(71) Applicant: Carlos Frade, Miami, FL (US)

(72) Inventor: Carlos Frade, Miami, FL (US)

(21) Appl. No.: 14/335,865

(22) Filed: Jul. 18, 2014

Related U.S. Application Data
(60) Provisional application No. 61/856,388, filed on Jul. 19, 2013.

(51) Int. Cl. B60F 5/02; B63B 35/74; B63B 21/56; B63B 35/58; B63B 35/85

(52) U.S. Cl. CPC B60F 5/02; B63B 35/58; B63B 35/85; B63B 21/56; B63B 35/74; B63B 2035/735
USPC 244/1 TD

(57) ABSTRACT

Our system and method for a towable and inflatable recreational device with a retractable wind foil. This towable and inflatable recreational device expands the existing field of art in the water sports recreational devices.

### CROSS-REFERENCE TO RELATED APPLICATIONS

Not Applicable

### SEQUENCE LISTING OR PROGRAM

Not Applicable

### PRIORITY

61/856,388 from Jul. 19, 2013

### BACKGROUND

1. Field

This application relates to inflatables and towable recreational devices.

2. Prior Art

This system and method for a towable and inflatable recreational device with a retractable wind foil, describes how a retractable wind foil connected to a towable raft will allow the setup to become aloft, and present a totally new perspective to the water sports arena.

Several inventions were made to allow a better performance in the water sports arena, Myerscough et al, in U.S. Pat. No. 8,376,798 described “This invention relates to a novel method and a novel inflatable flotation device for the method which are used in association with water sports boards such as kite boards, surfboards and the like, for the purpose of uprighting the water sports boards when inverted and encouraging the water sports boards to be moved by the wind in the direction of a water sports board rider when the rider becomes separated from the water sports board.”

Richardson & Zeh, EP 0783429, filed in 1994, “An improved water sports board having a low density high strength core surrounded by a soft resilient exterior layer. The elongated box-shaped core, constructed of low density light weight material covered by a high-strength composite skin, renders the board light and strong, and promotes controlled flexion, resilience, durability and maneuverability. The resilient non-permeable exterior layer forms the board's outer shape, promoting performance and rendering the board safe and comfortable to ride. Alternative embodiments in which the core contains of one or more cavities filled with gas, the pressure of which can be selectively varied, are also described.”

In 1983, Daoud filed under EP0170708, “Water sporting boat of the pedal type comprising a surfboard having a hollow keel at the stern into which is provided a mechanical transmission connected to one end of a rotary shaft, a propeller being mounted at the other end of the shaft, outside the hollow keel. Pedal power is transferred to the mechanical transmission by a chain drive also connected to a pedalling rack fixed on the surface of the surfboard. A steering rack, provided forwardly of the pedalling rack, is connected to a rudder, at the stern of the surfboard by a cable transmission. The steering rack includes a handle bar and the cable transmission is connected to the rudder so that the latter responds to the same steering direction as that applied by the handle bar.

In “Inflatable towable float”, Hendrickson filed under EP1612136 A1 in 2004, “a towable structure is configured to be towed behind a boat while floating above the surface of a body of water. In one implementation, the towable structure has a platform for supporting one or more passengers thereon extending between or otherwise supported by at least three water engaging base members. The base members are buoyant to extend above the surface of the body of water. The platform extends from a location sufficiently elevated on each of the base members so that the platform stays out of the water under normal operation when unloaded and when supporting one or more passengers.”

And in a recent 2011 filing, Patten filed under US 20120329347 A1, “An inflatable device has an inflatable bladder and a towing attachment point. The inflatable bladder has a top portion and a bottom portion. The towing attachment point is attached to the inflatable bladder for towing the inflatable device. A flocking layer is bonded directly to at least a part of the top portion, to form a rider receiving area, such that the rider can ride on the rider receiving area while the inflatable device is being towed via the towing attachment point.”

### SUMMARY

In light of the advancements in the water sports industry the customers and thrill seekers are constantly looking for a new and exciting type of ride. Our system and method describes a towable and inflatable raft that will allow the water sports community to experiment all the current available towable excitement with the add-on of a retractable wind foil. When placed in a refracted position the towable and inflatable device will stay on the water's surface while being towed forward by a boat or similar device that could propel forward.

Our system and method provides all the existing available water excitement while the wind foil is in the retracted position. When the wind foil is released to the deployed position, the wind foil will generate drag, which will aid it in its deployment. When the raft reaches a lift sustainable travel speed, or in other words, when enough “air speed” is generated over the wind foil, enough “lift” will be produced to lift off and the wind foil and raft will start an upward movement that will cause the raft to raise from the water. Once the raft is aloft, the raft operator and pilot will now have the capability to control the direction of the raft in the air, the directional control capability of our towable and inflatable recreational device is yet another characteristic of this new device that categorizes it into a new realm in the water sports recreational devices arena.

Our new system and method will have two modes of operation while aloft. One will be with the tow cable connected to the towing vessel. At that stage the pilot will have small input on the direction of the device as the vessel towing will have most of the input on the direction and height achieved by the device. The second mode of operation while aloft will be when the pilot chooses to disconnect the towing cable using the cable disconnect lever. When that action is performed the device will become an equivalent of an aircraft aloft and moving forward from the existing forward movement that was transferred by the towing vessel. Using the directional controls the pilot will take advantage of any wind currents available in the area and at this point will have full maneuverability of the devise aloft, but under gravity principles will be mostly in a gliding descent path. The pilot will then choose the most suitable landing location for the device, ideally in a location where it will be possible to reconnect with the towing vessel. After landing the pilot will proceed to retract the wind foil and from that point on the device will behave as a towable, floating on water raft again. New pilot and passengers would now be able to replace the previous crew and the towing vessel will proceed to tow the raft and to place it into the wind and the start of a new round of flights with this device.

In a preferred embodiment, this system and method for a towable and inflatable recreational device with a retractable wind foil comprising an operator controlled towable recreational device with release control where the operator can make the decision of remaining connected to the tow boat or free and flying away using the airfoil controls to get some directional control in the wind generated by the tow process. The wind foil starts the use of the device in the retractable position with a release control where the operator can release the wind foil which will produce drag against the forward action generated by the tow boat.

In this embodiment the operator can choose to activate the cable disconnect lever, from this point the device will be aloft, and the operator will use the provided flight controls to input directional commands to the device, the wind foil will have the form and appearance of a parachute generally in the square format and the wind foil will be connected to the device by suspension lines and links; the wind foil has a canopy and a vent; the device will float because of the air chambers inside the inner tubes, generally in the round form.

The device operator has a seat from where to comfortably operate the towable device while in the water, in ascending flight, in cruising altitude, and during descending flight with a restraining hardness will be used to keep the operator safely attached to the device with quick release in case of the emergency when the operator will have a wind foil emergency disconnect release; a safety altimeter will not allow this action to be performed if device is flying more than 5 feet in the air.

In another embodiment, possibly military version, the safety altimeter will have an altitude control, allowing the military operator much more control of the wind foil emergency disconnect release, as it could be adapted to mission requirements.

The float will have an external connector that allow a tow cable to be connected between the device and a tow boat, this apparatus that will allow a floating towable vehicle to become airborne due to the forward movement provided by the towing boat that is connected to the apparatus, comprising: of deployable and retractable wind foil connected to the floatable and towable device, our invention will provide means for airlifting a towable recreational device when there is a presence of sufficient airspeed with a release mechanism capable of releasing the wind foil from a retractable position, with directional control that will allow device pilot to have input control over the wind foil direction and wind foil storage capability;

### DRAWINGS

### Figures

The system and method for a towable and inflatable recreational device with a retractable wind foil is described by the appended claims in relation to the description of a preferred embodiment with reference to the following drawings which are described briefly as follows:

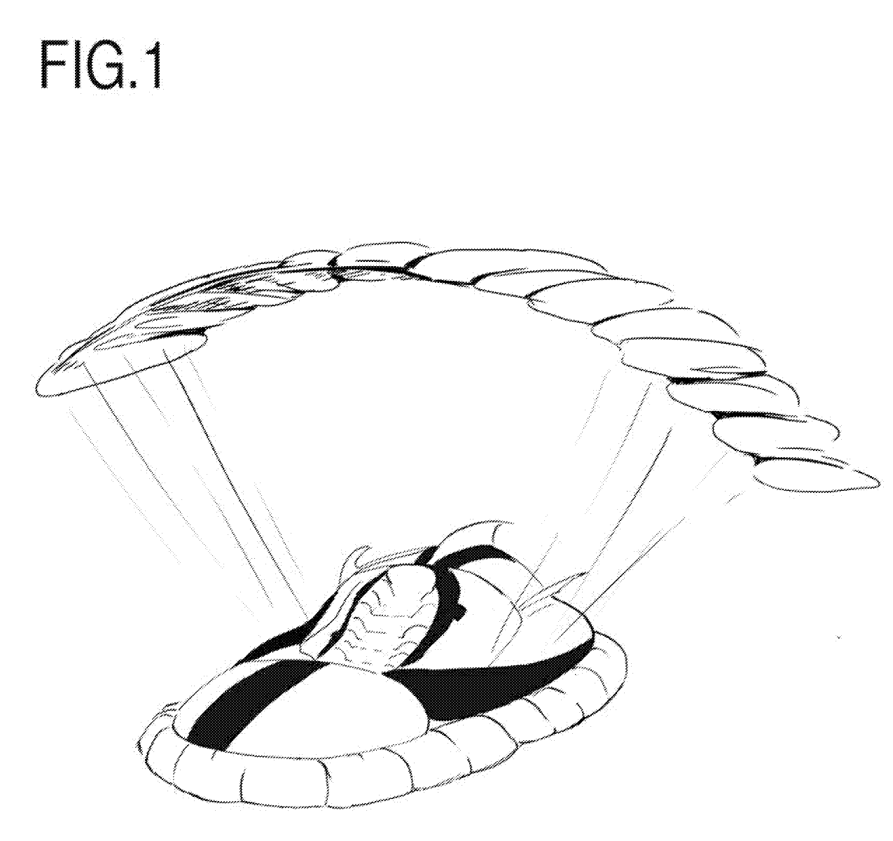

FIG. 1 displays the device with the wind foil in the deployed position;

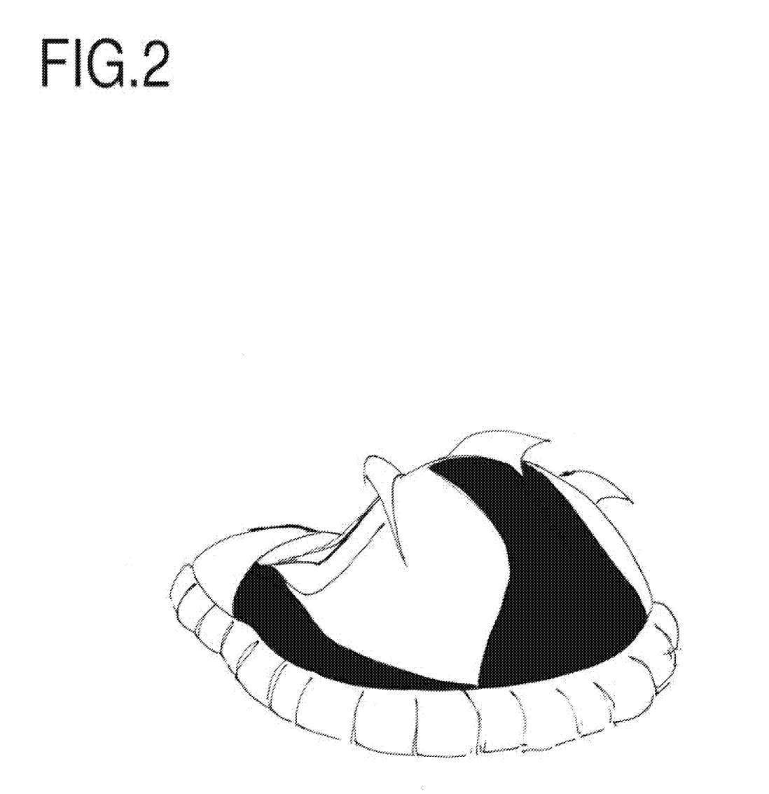

FIG. 2 displays the back of the device where the wind foil is in the retracted position;

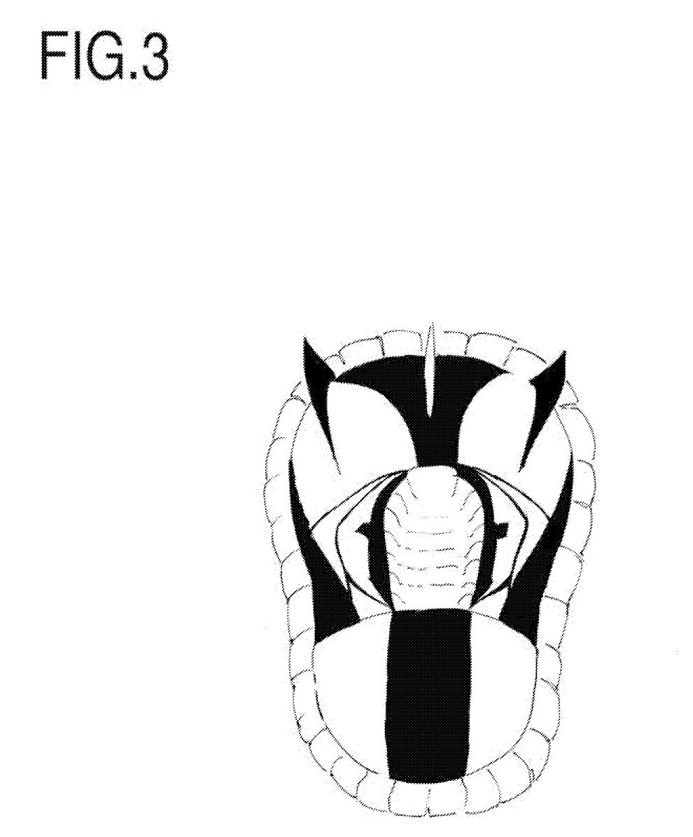

FIG. 3 displays a top view of the device.

What is claimed is:

1. A system and method for a towable and inflatable recreational device with a retractable wind foil comprising an operator controlled towable recreational device with release control where the operator can make the decision of remaining connected to the tow boat or free and flying away using the airfoil controls to get some directional control in the wind generated by the tow process;

2. The system and method in claim 1, wherein the wind foil starts the use of the device in the retractable position with a release control where the operator can release the wind foil which will produce drag against the forward action generated by the tow boat;

3. The system and method in claim 1, wherein the operator can choose to activate the cable disconnect lever, from this point the device will be aloft, and the operator will use the provided flight controls to input directional commands to the device;

4. The system and method in claim 1, wherein the wind foil will have the form and appearance of a parachute generally in the square format;

5. The system and method in claim 1, wherein the wind foil will be connected to the device by suspension lines and links;

6. The system and method in claim 1, wherein the wind foil has a canopy and a vent;

7. The system and method in claim 1, wherein the device will float because of the air chambers inside the inner tubes, generally in the round form;

8. The system and method in claim 1, wherein the device operator has a seating from where to comfortably operate the towable device while in the water, in ascending flight, in cruising altitude, and during descending flight;

9. The system and method in claim 1, wherein restraining hardness will be used to keep the operator safely attached to the device with quick release in case of the emergency;

10. The system and method in claim 1, wherein the operator will have a wind foil emergency disconnect release; a safety altimeter will not allow this action to be performed if device is flying more than 5 feet in the air;

11. The system and method in claim 1, in a military version, the safety altimeter will have an altitude control, allowing the military operator much more control of the wind foil emergency disconnect release, as it could be adapted to mission requirements;

12. The device of claim 7, wherein the float will have an external connector that allow a tow cable to be connected between the device and a tow boat;

13. An apparatus that will allow a floating towable vehicle to become airborne due to the forward movement provided by the towing boat that is connected to the apparatus, comprising: of deployable and retractable wind foil connected to the floatable and towable device

14. Means for airlifting a towable recreational device when there is a presence of sufficient airspeed;

15. The means described in claim 10, with a release mechanism capable of releasing the wind foil from a retractable position;

16. The means described in claim 10, with directional control that will allow device pilot to have input control over the wind foil direction;

17. The means described in claim 10, with wind foil storage capability;
